(19) United States
(12) Patent Application Publication
(10) Pub. No.: US 2026/0130356 A1
(43) Pub. Date: May 14, 2026

(54) LIQUID PRODUCT DISTRIBUTION FOR AGRICULTURAL SPRAYING SYSTEMS AND RELATED DEVICES AND METHODS

(71) Applicant: Ag Leader Technology, Ames, IA (US)

(72) Inventor: John Howard, Ames, IA (US)

(21) Appl. No.: 19/390,280

(22) Filed: Nov. 14, 2025

Related U.S. Application Data
(60) Provisional application No. 63/720,611, filed on Nov. 14, 2024.

(51) Int. Cl. A01M 7/00

(52) U.S. Cl. CPC A01M 7/0042; A01M 7/005; A01M 7/0089

(57) ABSTRACT

An agricultural sprayer comprising a first chemical supply tank; a pump configured to pump a broadcast chemical from the first liquid solution tank to plumbing on a boom for broadcast spraying; a second chemical supply tank; an injection pump configured to pump a selective spray chemical from the second liquid solution tank to plumbing on a boom for selective spraying; and a mixing chamber for mixing the broadcast chemical and the selective spray chemical prior to spraying.

### CROSS-REFERENCE TO RELATED APPLICATION(S)

This application claims the benefit under 35 U.S.C. § 119(e) to U.S. Provisional Application 63/720,611, filed Nov. 14, 2024, and entitled Liquid Product Distribution for See and Spray Systems, which is hereby incorporated herein by reference in its entirety for all purposes.

### TECHNICAL FIELD

The disclosure relates to agricultural spraying systems, specifically sprayers with multiple liquid application systems.

### BACKGROUND

Various agricultural sprayers would be known to those of skill in the art. A traditional known broadcast sprayer 2 is shown in FIG. 1. In this traditional known broadcast sprayer 2 the liquid product flows from a solution tank 4 to spray nozzles 10 for application. Various additional components may be included

on a sprayer 2 such as ball valves, filters, chemical inductors, agitation and rinse circuits, and the like but are omitted in FIG. 1 for simplicity and clarity but would be understood and appreciated by those of skill in the art.

In this example of a traditional broadcast sprayer 2, a remote chemical supply tank 4 is connected to the fill port 6 such that the liquid product may be pumped into the liquid solution tank 4. A pump 8 is used to move the liquid from the liquid solution tank 4 to the spray nozzles 10, such as through boom plumbing 12.

In certain sprayers 2, the speed of the pump 8 may be varied to control the flow rate of liquid to meet the required volume of liquid applied. A flow meter 14 may optionally be used as feedback to an electronic control system to determine adjustments to the pump 8 speed. Product flow rate may also be controlled by using an in-line servo valve, an excess flow by-pass valve, or by PWM (pulse width modulation) of the spray nozzles.

Various sensor-based sprayer liquid control systems 20 are also known in the art. These sensor-based sprayer control systems 20 may support simultaneous, nozzle-by-nozzle, broadcast spraying while selectively spraying pests, though a secondary liquid system, when a condition is present. Such a sprayer 2 implementing a known sensor-based sprayer liquid control system 20 capable of both broadcast and selective application is shown in FIG. 2.

FIG. 2 shows the flow of a liquid from filling the sprayer 2 to applying both the broadcast spray and selective spray products. Various additional components may be included on a sprayer 2 such as ball valves, filters, chemical inductors, agitation and rinse circuits, and the like but are omitted in FIG. 2 for simplicity and clarity but would be understood and appreciated by those of skill in the art.

Like the traditional broadcast sprayer 2 discussed above, a remote chemical supply tank 4A, for broadcast chemicals, is connected to the fill port 6A and the liquid is pumped into the liquid solution tank 4A. A pump 8A is used to move liquid from the liquid solution tank 4A to the spray nozzles 10A via the boom plumbing 12A. Optionally, the sprayer 2 may also include a flow meter 14A, as would be understood.

For the selective spray, a second remote chemical supply tank 4B, for selective spray chemicals, is connected to a fill port 6B such that a liquid may be pumped into the liquid solution tank 4B. A pump 8B is used to move liquid from the liquid solution tank 4B to the spray nozzles 10B via boom plumbing 12B.

In this example the speed of product pump 8B may be varied to control the liquid chemical to a desired pressure. A pressure sensor 16 is used as feedback for pressure control.

### BRIEF SUMMARY

Disclosed herein are various agricultural spraying systems, specifically sprayers equipped for application two or more distinct products. That is, sprayers having a multiple liquid application system. Various of the disclosed systems are designed to simultaneously broadcast spray with one product and selectively spray with another product. The system includes two sets of liquid application components. One set of liquid application components used for broadcast spray. The other set of liquid application components used for selective spray. Optionally, the broadcast spray is used for application of less expensive product(s) that often have a residual chemical, while the selective spray is used for more expensive, and potentially more effective chemicals.
In Example 1, an agricultural sprayer comprising a first chemical supply tank, a product pump configured to pump a broadcast chemical from the first liquid solution tank to plumbing on a boom for broadcast spraying, a second chemical supply tank, an injection pump configured to pump a selective spray chemical from the second liquid solution tank to plumbing on a boom for selective spraying, and a mixing chamber for mixing the broadcast chemical and the selective spray chemical prior to spraying.
Example 2 relates to the agricultural sprayer of any of Examples 1 and 3-7, wherein the mixing chamber is disposed on the boom.
Example 3 relates to the agricultural sprayer of any of Examples 1-2 and 4-7, further comprising a control system configured for control of the product pump, injection pump, and a first set of spray nozzles in communication with the product pump and second set of spray nozzles in communication with the mixing chamber.
Example 4 relates to the agricultural sprayer of any of Examples 1-3 and 5-7, wherein the control system selective turns the first set of spray nozzles and second set of spray nozzles on and off based on a detected field condition.
Example 5 relates to the agricultural sprayer of any of Examples 1-4 and 6-7, wherein the detected field condition is one or more of a weed, an insect, a disease, and a nutrient deficiency.
Example 6 relates to the agricultural sprayer of any of Examples 1-5 and 7, wherein the control system selective turns the first set of spray nozzles and second set of spray nozzles on and off based on a detected field condition on a geo-referenced map.
Example 7 relates to the agricultural sprayer of any of Examples 1-6, wherein the detected field condition is one or more of a weed, an insect, a disease, and a nutrient deficiency.
In Example 8, an agricultural spraying system comprising a first tank, a first pump in communication with the first tank, a first set of spray nozzles in fluidic communication with the first pump, a second tank, a second pump in communication with the second tank, a mixing chamber in fluidic communication with the first pump and the second pump, and a second set of spray nozzles in fluidic communication with the mixing chamber.
Example 9 relates to the agricultural spraying system of any of Examples 8 and 10-16, wherein the mixing chamber is disposed on a sprayer boom.
Example 10 relates to the agricultural spraying system of any of Examples 8-9 and 11-16, wherein the second pump is a positive displacement pump.
Example 11 relates to the agricultural spraying system of any of Examples 8-10 and 12-16, further comprising a control system configured for control of the first pump, second pump, first set of spray nozzles and second set of spray nozzles.
Example 12 relates to the agricultural spraying system of any of Examples 8-11 and 13-16, wherein the control system selective turns the first set of spray nozzles and second set of spray nozzles on and off based on a detected field condition.
Example 13 relates to the agricultural spraying system of any of Examples 8-12 and 14-16, wherein the detected field condition is one or more of a weed, an insect, a disease, and a nutrient deficiency.
Example 14 relates to the agricultural spraying system of any of Examples 8-13 and 15-16, wherein the control system selective turns the first set of spray nozzles and second set of spray nozzles on and off based on a detected field condition on a geo-referenced map.
Example 15 relates to the agricultural spraying system of any of Examples 8-14 and 16, wherein the detected field condition is one or more of a weed, an insect, a disease, and a nutrient deficiency.
Example 16 relates to the agricultural spraying system of any of Examples 8-15, wherein the first tank comprises a broadcast chemical and the second tank comprises a concentrated selective spray chemical.
In Example 17, a multiple application spraying system comprising a broadcast spraying system comprising a first tank a first pump in communication with the first tank, and a first set of spray nozzles in communication with the first pump. The multiple application spraying system also comprising a selective spraying system comprising a second tank, a second pump in communication with the second tank, a mixing chamber in communication with the first pump and the second pump, and a second set of spray nozzles in communication with the mixing chamber. The multiple application spraying system also comprising a control system configured to selective control the first pump, the second pump, the first set of spray nozzles and the second set of spray nozzles based on a detected field condition.
Example 18 relates to the multiple application spraying system of any of Examples 17 and 19-20, wherein the detected field condition is one or more of a weed, an insect, a disease, and a nutrient deficiency.
Example 19 relates to the multiple application spraying system of any of Examples 17-18 and 20, wherein the second pump is a positive displacement pump.
Example 20 relates to the multiple application spraying system of any of Examples 17-19, wherein the mixing chamber is disposed on a sprayer boom.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic diagram of an agricultural sprayer, according to one implementation.

FIG. 2 is a schematic diagram of an agricultural sprayer, according to one implementation.

FIG. 3 is a schematic diagram of an agricultural sprayer, according to one implementation.

FIG. 4 is a schematic diagram of a sprayer manifold having a mixer, according to one implementation.

FIG. 5 is a schematic diagram of a sprayer boom having paired spray nozzles, according to one implementation.

### DETAILED DESCRIPTION

Disclosed herein is an agricultural spraying system configured to be able to apply two or more chemicals including, optionally, both broadcast spraying and selective spraying. The disclosed system aims to simplify prior known spray systems by eliminating many of the duplicate liquid application components.

The disclosed systems, methods and devices, lower the cost, weight, and complexity of multiple application sprayer systems. That is, various prior known multiple application systems are equipped with a series of sensors (e.g., cameras), graphics processors, and a central computer, that are interfaced to the application system. These additional sensors and related components are used to identify conditions for the selective spray to target. These extra components add a large amount of weight to the sprayer chassis and sprayer booms. Due to the extra weight factory/standard booms need to be replaced with custom booms that are much stronger than the factory/standard booms. The cost and complexity of the prior known multiple application sprayer system are barriers deterring the mass market from adopting the use of multiple application sprayer systems.

As used herein “broadcast spraying” is spraying a product, chemical, or chemical mix to an entire field or large portion thereof, as would be understood by those of skill in the art.

As used herein “selective spray” is selectively spraying weeds, pests, or other target areas, as would be understood by those of skill in the art.

As used herein a “condition” means a weed, insect, disease, nutrient deficiency, or the like that may be a target for selective spray, as would be understood by those of skill in the art.

As used herein a “chemical” means a herbicide, insecticide, fungicide, nutrient, biological, combination thereof, or the like, that may be applied by a sprayer, as would be understood by those of skill in the art.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 1 , 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” and U.S. Patent Application 63,906,646, filed Oct. 28, 2025, entitled “Automated Grail Filling System and Related Devices and Methods,” each of which is incorporated herein by reference.

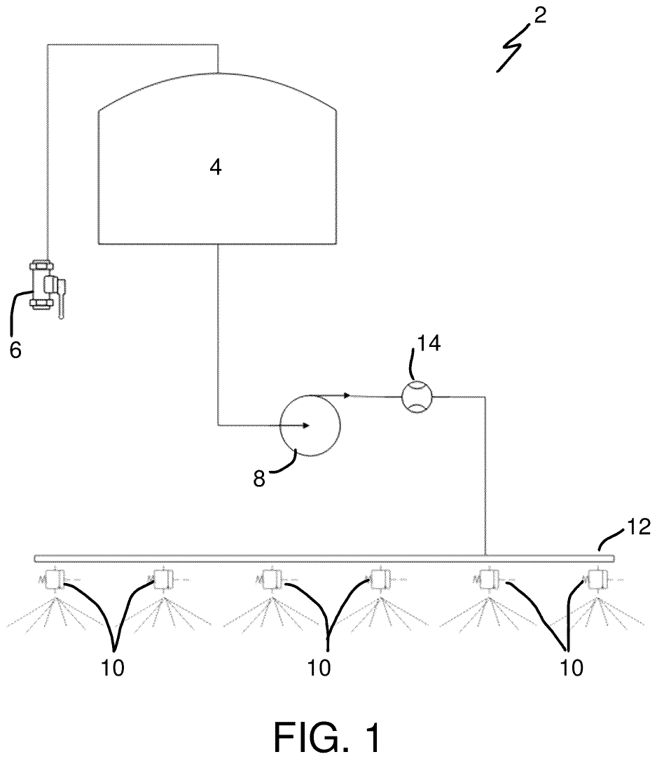

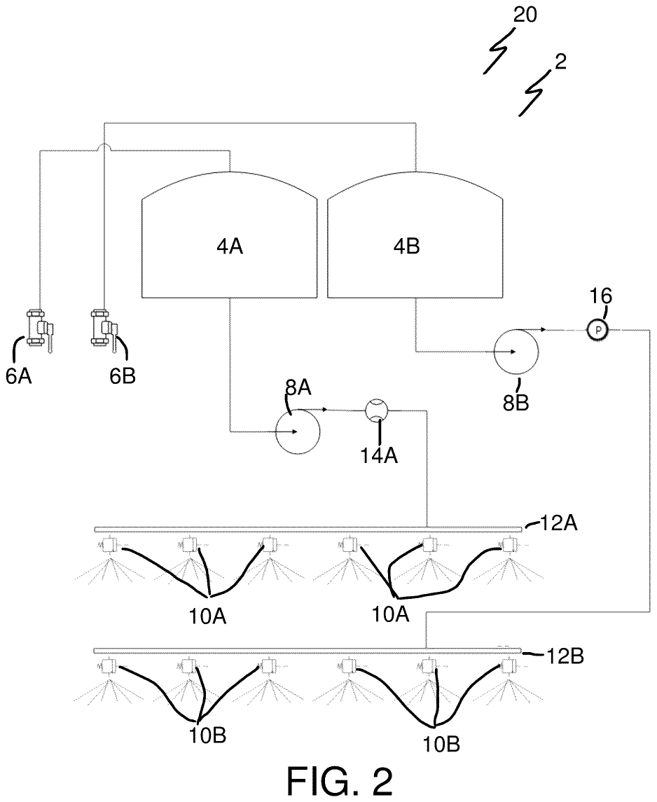

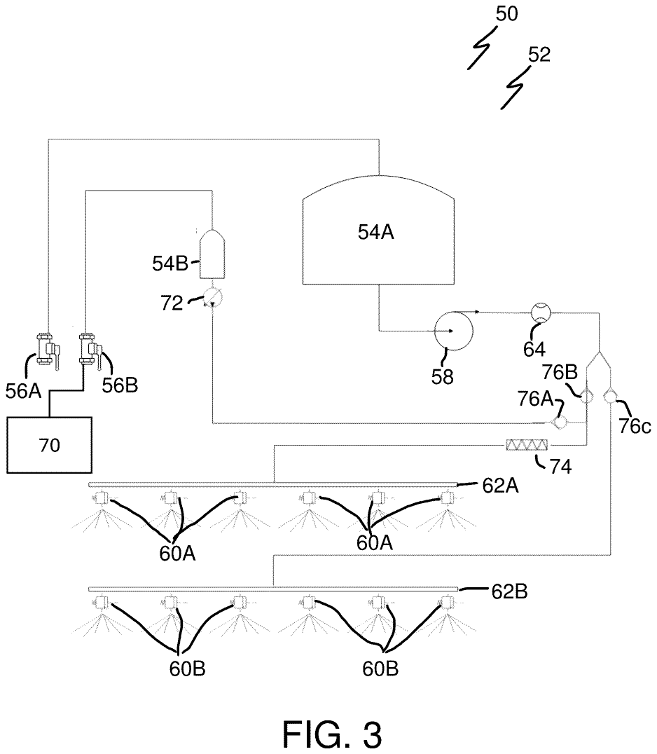

Turning now to the figures in more detail, FIG. 3 shows an exemplary diagram of a sprayer 50 having a multiple application sprayer system 52 is shown. In various implementations, a remote chemical supply tank 54A, for broadcast application, is connected to the fill port 56A such that the liquid product can be pumped into the liquid solution tank 54A. A pump 58 is used to move liquid from the liquid solution tank 54 to spray nozzles 60A via the boom plumbing 62A, similar to the previously described systems 2 of FIGS. 1 and 2.

In various implementations, the speed of the pump 58 is varied to control the flow rate of product to meet the required volume of product to be applied. In certain implementations, a flow meter 64 is used as feedback into the electronic control system to determine adjustments to the pump speed. Product flow rate may alternatively be controlled by using an in-line servo valve, an excess flow by-pass valve, or by PWM modulation of the spray nozzles.

Continuing with FIG. 3, a remote chemical supply tank 70, for the selective spray liquid, is connected to the fill port 56B such that and the liquid product can be pumped into the liquid solution tank 54B. The injection pump 72, such as a positive displacement pump 72, is used to move the liquid from the tank 54B to the spray nozzles 60B via the boom plumbing 62B.

In these and other implementations, the speed of pump 72 is varied to control the flow rate of product to meet the required volume of product to be applied. In various implementations where the pump 72 is a positive displacement, a rotational sensor may be integrated into the pump for feedback and control of the flow rate, as would be understood.

Optionally, the liquid for selective spraying is a concentrated liquid. In these implementations, a mixing chamber 74 blends the selective spray liquid with the broadcast chemical for even distribution in a combined mix.

In certain implementations, check valves 76A, 76B, 76C are located on various portions of the plumbing to prevent undesired back flow of liquids within the system 52.

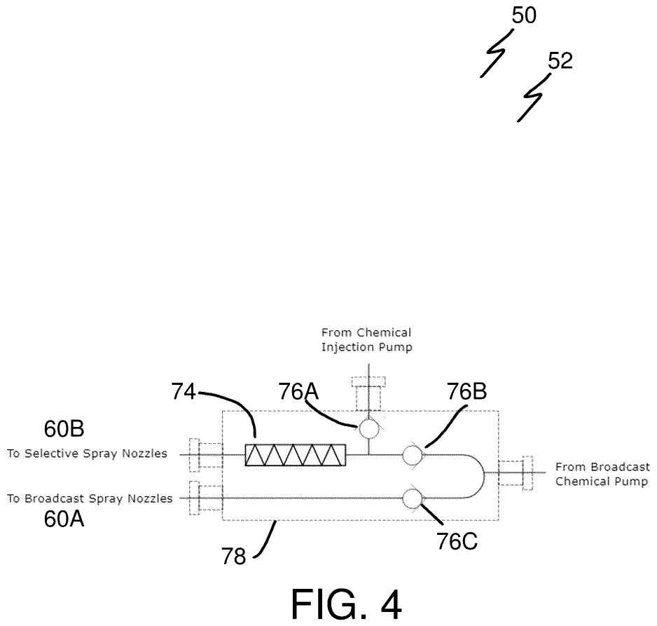

In certain further implementation, the system 52 may include a mixer and check valve assembly 78, as shown in FIG. 4. In these and other implementations, the assembly 78 combines the various check valves 76A, 76B, 76C and mixer 74 into a compact assembly/manifold 74.

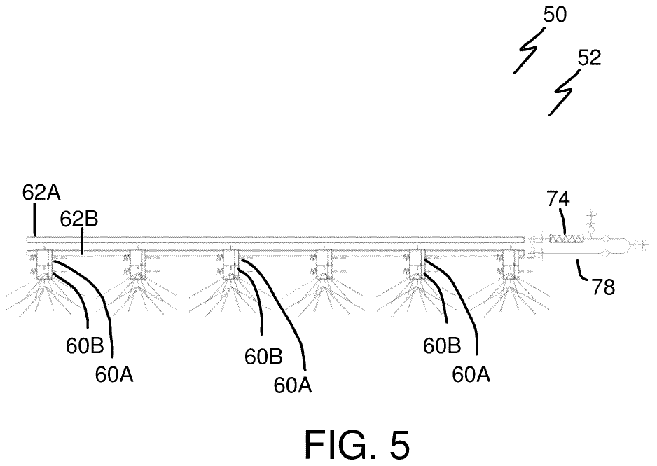

In various further implementation, the assembly/manifold 74 may be mounted directly to the boom plumbing 62A, 62B as shown for example in FIG. 5. This may further simplify the sprayer 50 plumbing. As would be understood, sprayers 50 with large booms may require multiple manifolds placed across the width of the boom.

Turning back to FIG. 4, in use, the broadcast spray nozzle 60A boom 62A line may function such that output from the main product pump 58 is regulated to match the flow rate required by ground speed, product application rate, and the width of boom that is currently turned on. Flow rate can be regulated by varying pump 58 speed, use of an in-line servo valve, or by-pass servo valve. Individual nozzles are commanded on/off by physical boom switches, software switches in the control system, automatic on/off control based upon prior field coverage, or any combination of these.

The selective spray nozzle 60B boom line 62B may function such that the output from the chemical injection pump 72 is regulated to match the flow rate required by ground speed, product application rate, and the width of boom that is currently turned on. Flow rate may be regulated by varying pump 72 speed. Individual nozzles can be commanded on/off by physical boom switches, software switches in the control system, automatic on/off control based upon prior field coverage, or for selectively spraying based upon conditions.

In various implementations the multiple application spraying system 52 includes at least three different modes. In a first mode, the broadcast spraying a tank 54 includes a chemical or mix of chemicals. In this mode, product from the main product tank 54 is dispensed through the boom line 62A and broadcast spray nozzles 62B.

In a second mode, the system 52 is configured for broadcast spraying a tank 54 mix of chemicals in addition to a selective spraying of an injected chemical or chemical mix from the tank 54B. Using this method, product is dispensed from both the chemical injection product tank 54B and the main product tank 54A through boom line 62B and selective spray nozzles 60B. In this mode, the broadcast spray nozzles 60A are closed.

In a third mode, the system 52 is configured for broadcast spraying a tank 54A mix of chemicals in unison with selectively spraying an injected chemical or chemical mix from the tank 54B based upon detection of a condition or using a georeferenced map indicating previously detected conditions.

In certain implementations, nozzles 60A, 60B on the broadcast spray nozzle boom line 62A and the selective spray nozzle boom line 62B are “paired” with each other in a fore/aft relationship, shown for example in FIG. 5. In the third mode, the broadcast spray nozzle boom line 62B is filled with chemical from the main product tank 54 and the selective spray nozzle boom line 62B is filled with chemical from the main product tank 54A after being combined with chemical from the chemical injection product tank 54B by the in-line mixer 74, optionally located in the manifold 78.

In the third mode, when a condition is detected, one or more selective nozzles 60B are turned on to spray the mix of broadcast chemicals and the selective spray chemical on the pests/target area. Paired broadcast spray nozzles 60A may remain on if additional broadcast chemical being sprayed on the area is desired. The amount of extra spray can be determined by the size of the spray nozzle 60A. Paired broadcast spray nozzles 60A can be turned off if double application of the broadcast chemicals is not desired. Once pests or the condition is no longer detected the selective spray nozzles 60B are shut off and the broadcast nozzles 60A are turned back on, if not already on.

The control system 52 may contain settings for fore/aft and side to side look-a heads to provide desired levels of overlap during the nozzle switching process.

As would be understood in light of this disclosure, the spray system 52 lowers the cost and weight of the components required for simultaneous broadcast and selective chemical spraying. Additionally, when retrofitting an existing sprayer with the herein disclosed system 52 the factory boom may not need to be replaced. Further, the main product tank 54 and pluming would not necessarily need to be replaced.

A further advantage of the system 52 includes requiring fewer machine refills due to the volume of the main product tank 54 not being reduced. That is, the current disclosed system 52 maintains productivity.

Still further, the disclosed system will be more affordable than currently known and available products.

Although the disclosure has been described with references to various embodiments, persons skilled in the art will recognize that changes may be made in form and detail without departing from the spirit and scope of this disclosure.

What is claimed is:

1. An agricultural sprayer comprising:
(a) a first chemical supply tank;
(b) a product pump configured to pump a broadcast chemical from the first liquid solution tank to plumbing on a boom for broadcast spraying;
(c) a second chemical supply tank;
(d) an injection pump configured to pump a selective spray chemical from the second liquid solution tank to plumbing on a boom for selective spraying; and
(e) a mixing chamber for mixing the broadcast chemical and the selective spray chemical prior to spraying.

2. The agricultural sprayer of claim 1, wherein the mixing chamber is disposed on the boom.

3. The agricultural sprayer of claim 1, further comprising a control system configured for control of the product pump, injection pump, and a first set of spray nozzles in communication with the product pump and second set of spray nozzles in communication with the mixing chamber.

4. The agricultural sprayer of claim 3, wherein the control system selective turns the first set of spray nozzles and second set of spray nozzles on and off based on a detected field condition.

5. The agricultural sprayer of claim 4, wherein the detected field condition is one or more of a weed, an insect, a disease, and a nutrient deficiency.

6. The agricultural sprayer of claim 3, wherein the control system selective turns the first set of spray nozzles and second set of spray nozzles on and off based on a detected field condition on a geo-referenced map.

7. The agricultural sprayer of claim 6, wherein the detected field condition is one or more of a weed, an insect, a disease, and a nutrient deficiency.

8. An agricultural spraying system comprising:
(a) a first tank;
(b) a first pump in communication with the first tank;
(c) a first set of spray nozzles in fluidic communication with the first pump;
(d) a second tank;
(e) a second pump in communication with the second tank;
(f) a mixing chamber in fluidic communication with the first pump and the second pump; and
(g) a second set of spray nozzles in fluidic communication with the mixing chamber.

9. The agricultural spraying system of claim 8, wherein the mixing chamber is disposed on a sprayer boom.

10. The agricultural spraying system of claim 8, wherein the second pump is a positive displacement pump.

11. The agricultural spraying system of claim 8, further comprising a control system configured for control of the first pump, second pump, first set of spray nozzles and second set of spray nozzles.

12. The agricultural spraying system of claim 11, wherein the control system selective turns the first set of spray nozzles and second set of spray nozzles on and off based on a detected field condition.

13. The agricultural spraying system of claim 12, wherein the detected field condition is one or more of a weed, an insect, a disease, and a nutrient deficiency.

14. The agricultural spraying system of claim 11, wherein the control system selective turns the first set of spray nozzles and second set of spray nozzles on and off based on a detected field condition on a geo-referenced map.

15. The agricultural spraying system of claim 13, wherein the detected field condition is one or more of a weed, an insect, a disease, and a nutrient deficiency.

16. The agricultural spraying system of claim 8, wherein the first tank comprises a broadcast chemical and the second tank comprises a concentrated selective spray chemical.

17. A multiple application spraying system comprising:
(a) a broadcast spraying system comprising:
(i) a first tank;
(ii) a first pump in communication with the first tank; and
(iii) a first set of spray nozzles in communication with the first pump;
(b) a selective spraying system comprising:
(i) a second tank;
(ii) a second pump in communication with the second tank;
(iii) a mixing chamber in communication with the first pump and the second pump; and
(iv) a second set of spray nozzles in communication with the mixing chamber; and
(c) a control system configured to selective control the first pump, the second pump, the first set of spray nozzles and the second set of spray nozzles based on a detected field condition.

18. The multiple application spraying system of claim 17, wherein the detected field condition is one or more of a weed, an insect, a disease, and a nutrient deficiency.

19. The multiple application spraying system of claim 17, wherein the second pump is a positive displacement pump.

20. The multiple application spraying system of claim 17, wherein the mixing chamber is disposed on a sprayer boom.
